(19) United States
(12) Patent Application Publication
(10) Pub. No.: US 2026/0251962 A1
(43) Pub. Date: Aug. 27, 2026

(54) CAMERA MODULE

(71) Applicant: Samsung Electro-Mechanics Co., Ltd., Suwon-si (KR)

(72) Inventors: Young Hwan KWON, Suwon-si (KR); Byung Woo KANG, Suwon-si (KR); Young Bok YOON, Suwon-si (KR); Bo Sung SEO, Suwon-si (KR)

(73) Assignee: Samsung Electro-Mechanics Co., Ltd., Suwon-si (KR)

(21) Appl. No.: 19/543,426

(22) Filed: Feb. 18, 2026

(30) Foreign Application Priority Data
Feb. 25, 2025 (KR) 10-2025-0024492
Jan. 15, 2026 (KR) 10-2026-0007876

(51) Int. Cl. G03B 17/17; G02B 7/09; G02B 7/18; G03B 3/10; G03B 17/12

(52) U.S. Cl. CPC G03B 17/17; G02B 7/09; G02B 7/1805; G03B 3/10; G03B 17/12

(57) ABSTRACT

A camera module includes a housing, first, second, and third optical modules sequentially arranged in an internal space of the housing along a propagation path of light, and a fourth optical module disposed in the housing to receive light passing through the third optical module. The first through third optical modules are arranged to overlap in a first direction, and the first through fourth optical modules are arranged to satisfy the conditional expression d1 > d2, where d1 is a distance in a second direction perpendicular to the first direction from a center of an optical member in the first optical module to an outermost end of the optical member in the first optical module, and d2 is a distance in the second direction from a center of an optical member in the fourth optical module to the outermost end of the optical member included in the first optical module.

### CROSS-REFERENCE TO RELATED APPLICATIONS

This application claims the benefit under 35 USC 119(a) of Korean Patent Application Nos. 10-2025-0024492 filed on February 25, 2025, and 10-2026-0007876 filed on January 15, 2026, in the Korean Intellectual Property Office, the entire disclosures of which are incorporated herein by reference for all purposes.

### BACKGROUND

### 1. Field

The present disclosure relates to a camera module.

### 2. Description of the Background

A camera module disposed in a mobile device has continuously evolved to have performance comparable to that of a conventional traditional camera. In particular, as a frequency of capturing videos or photographs using a mobile device has increased, a demand for a camera module capable of providing a high zoom magnification has gradually increased.

In order to respond to such a demand, a reflection member for changing a propagation path of light has been applied to a mobile camera, and furthermore, a structure has also been proposed in which a lens is additionally disposed in front of the reflection member for the purpose of further improving performance of the camera.

For example, the reflection member may bend the propagation path of light, thereby allowing lenses to be stacked in a direction other than a thickness direction of the mobile device, which is advantageous in reducing a thickness of the camera module.

Meanwhile, recently, demand for a camera module having an overall more compact size by reducing not only a thickness of the camera module but also a length thereof while maintaining high performance has increased.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a housing having an internal space, a first optical module, a second optical module, and a third optical module sequentially arranged in the internal space of the housing along a propagation path of light, and a fourth optical module disposed in the housing and configured to receive light passing through the third optical module, wherein the first optical module, the second optical module, and the third optical module are arranged to overlap one another in a first direction, and the first optical module, the second optical module, the third optical module, and the fourth optical module are arranged in the housing to satisfy the following conditional expression: d1 > d2, where d1 is a distance in a second direction from a center of an optical member included in the first optical module to an outermost end of the optical member included in the first optical module, and d2 is a distance in the second direction from a center of an optical member included in the fourth optical module to the outermost end of the optical member included in the first optical module, the second direction being a direction perpendicular to the first direction.

The first optical module may include a first reflection member configured to change a traveling direction of light incident in a direction parallel to a first optical axis into a direction parallel to a second optical axis. The second optical module may include one or more lenses disposed in the direction parallel to the second optical axis. The third optical module may include a second reflection member configured to change a traveling direction of light incident in the direction parallel to the second optical axis a plurality of times. The first direction may be the direction parallel to the second optical axis.

The first optical module, the second optical module, the third optical module, and the fourth optical module may further satisfy the following conditional expression: d3 > 0, where d3 is a distance in the second direction from the second optical axis to the center of an optical member included in the fourth optical module.

The first reflection member may have a minor axis parallel to the first direction and a major axis parallel to the second direction, and the outermost end of the optical member included in the first optical module may be one end of the first reflection member in a major axis direction.

The first reflection member may include an incident surface on which light may be incident, an exit surface from which light may be emitted, and a reflection surface on which light incident on the incident surface may be reflected toward the exit surface, and one or more of the incident surface and the exit surface may have a curvature in a paraxial region.

The first optical module may include one or more lenses disposed on an object side of the first reflection member and disposed in a direction parallel to the first optical axis, and the outermost end of the optical member included in the first optical module may be one end of a lens having a maximum outer diameter among the one or more lenses.

The second reflection member may include a first reflection surface on which light incident in the direction parallel to the second optical axis may be reflected into a direction parallel to a third optical axis, and a second reflection surface on which light incident in the direction parallel to the third optical axis may be reflected into a direction parallel to a fourth optical axis.

The second reflection member may include a reflection surface having an angle other than 45 degrees with respect to the second optical axis.

The first optical module may be configured to be rotatable with respect to the housing about a first rotation axis and a second rotation axis perpendicular to each other, and the second optical module or the third optical module may be configured to be movable with respect to the housing in a direction parallel to the second optical axis.

The first rotation axis may be parallel to the second optical axis.

The first optical module may include a reflection member holder in which the first reflection member is disposed, and a rotation guide in which the reflection member holder is disposed, a first ball member may be disposed between the reflection member holder and the rotation guide and spaced apart in a direction of the first rotation axis, and a second ball member may be disposed between the rotation guide and the housing and spaced apart in a direction of the second rotation axis.

The second optical module or the third optical module may include a carrier in which an optical member may be mounted, and a plurality of ball members disposed between the carrier and the housing and configured to guide movement of the carrier in the direction parallel to the second optical axis.

One side of the carrier may extend further than the other side of the carrier in the direction parallel to the second optical axis, the plurality of ball members may be divided and disposed on the one side and the other side of the carrier, and the number of ball members disposed on the one side of the carrier may be greater than the number of ball members disposed on the other side of the carrier.

The second optical module may be configured to move in the direction parallel to the second optical axis, and the housing may include surfaces parallel to reflection surfaces of the second reflection member.

In another general aspect, a camera module includes a housing having a length in a first direction and a second direction perpendicular to the first direction, a first optical module disposed in a first space of the housing, a second optical module disposed in a second space of the housing, and a third optical module disposed in a third space of the housing, wherein the first space, the second space, and the third space are sequentially arranged in the first direction and have different lengths in the second direction.

Among the first space, the second space, and the third space, the second space may have a minimum length in the second direction, and the third space may have a maximum length in the second direction.

The camera module may further include an image sensor module including an image sensor disposed in the housing and facing the third optical module. The first optical module, the second optical module, the third optical module, and the image sensor module may be disposed in the housing to satisfy the following conditional expression: d1 > d2, where d1 is a distance in the second direction from a center of an optical member included in the first optical module to an outermost end of the optical member included in the first optical module, and d2 is a distance in the second direction from a center of the image sensor to the outermost end of the optical member included in the first optical module.

The first optical module may include a first reflection member configured to change a traveling direction of light incident in a direction parallel to a first optical axis into a direction parallel to a second optical axis, and light emitted from the first optical module may sequentially pass through the second optical module and the third optical module.

The first optical module, the second optical module, the third optical module, and the image sensor module may further satisfy the following conditional expression: d3 > 0, where d3 is a distance in the second direction from the second optical axis to the center of the image sensor.

The first optical module may further include a first lens unit disposed on an object side of the first reflection member, and a maximum outer diameter of the first lens unit may be greater than a length of the first reflection member in a length direction.

The third optical module may include a second reflection member, the second reflection member may include a first reflection surface on which a traveling direction of light incident in the direction parallel to the second optical axis may be changed into a direction parallel to a third optical axis, and a second reflection surface which may be spaced apart from the first reflection surface in a direction of the third optical axis and on which a traveling direction of light incident in the direction parallel to the third optical axis may be changed into a direction parallel to a fourth optical axis.

In another general aspect, a camera module includes a first lens unit including one or more lenses disposed in a first optical axis direction, a first reflection member spaced apart from the first lens unit in the first optical axis direction, a second lens unit spaced apart from the first reflection member in a second optical axis direction and including one or more lenses disposed in the second optical axis direction, a second reflection member spaced apart from the second lens unit in the second optical axis direction and including a plurality of reflection surfaces, and an image sensor facing the second reflection member.

The first reflection member may be configured to be rotatable about a first rotation axis and a second rotation axis perpendicular to each other, and one of the first rotation axis and the second rotation axis may be parallel to the second optical axis direction.

The first lens unit may be rotated together with the first reflection member about the first rotation axis and the second rotation axis.

The second reflection member may include a first reflection surface and a second reflection surface spaced apart from each other in a third optical axis direction perpendicular to the second optical axis direction.

One of the second lens unit and the second reflection member may be configured to be movable in the second optical axis direction.

Other features and aspects will be apparent from the following detailed description, the drawings, and the claims.

### BRIEF DESCRIPTION OF DRAWINGS

FIG. 1 is a perspective view of a camera module (a first example embodiment) according to the present disclosure.

FIG. 2 is a plan view of the camera module according to the present disclosure while a shield can is removed.

FIG. 3 is a schematic exploded perspective view of the camera module according to the present disclosure.

FIG. 4 is a plan view of a housing according to the present disclosure.

FIG. 5 is a perspective view of a first optical module according to the present disclosure.

FIG. 6 is an exploded perspective view of the first optical module according to the present disclosure.

FIG. 7 is a cross-sectional view taken along line I-I' of FIG. 5.

FIG. 8 is a cross-sectional view taken along line II-II' of FIG. 5.

FIG. 9 is an exploded perspective view of a second optical module according to the present disclosure.

FIG. 10 is a perspective view of a third optical module according to the present disclosure.

FIG. 11 is an exploded perspective view of the third optical module according to the present disclosure.

FIG. 12 is a plan view of a third space of the housing according to the present disclosure.

FIG. 13 is a view illustrating an autofocus (AF) driving state of the third optical module according to the present disclosure.

FIG. 14 is a schematic plan view of a camera module (a second example embodiment) according to the present disclosure.

FIG. 15 is a schematic plan view of a camera module (a third example embodiment) according to the present disclosure.

FIGS. 16A through 16C are views illustrating modified example embodiments of a third optical module included in the camera module illustrated in FIG. 15.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being "on," "connected to," or "coupled to" another element, it may be directly "on," "connected to," or "coupled to" the other element, or there may be one or more other elements intervening therebetween. In contrast, when an element is described as being "directly on," "directly connected to," or "directly coupled to" another element, there can be no other elements intervening therebetween.

As used herein, the term "and/or" includes any one and any combination of any two or more of the associated listed items; likewise, "at least one of" includes any one and any combination of any two or more of the associated listed items.

Although terms such as "first," "second," and "third" may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as "above," "upper," "below," "lower," and the like, may be used herein for ease of description to describe one element’s relationship to another element as shown in the figures. Such spatially relative terms are intended to encompass different orientations of the device in use or operation in addition to the orientation depicted in the figures. For example, if the device in the figures is turned over, an element described as being "above," or "upper" relative to another element would then be "below," or "lower" relative to the other element. Thus, the term "above" encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles "a," "an," and "the" are intended to include the plural forms as well, unless the context clearly indicates otherwise. The terms "comprises," "includes," and "has" specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term "may" with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

An aspect of the present disclosure is to provide a camera module having an overall compact size and improved performance.

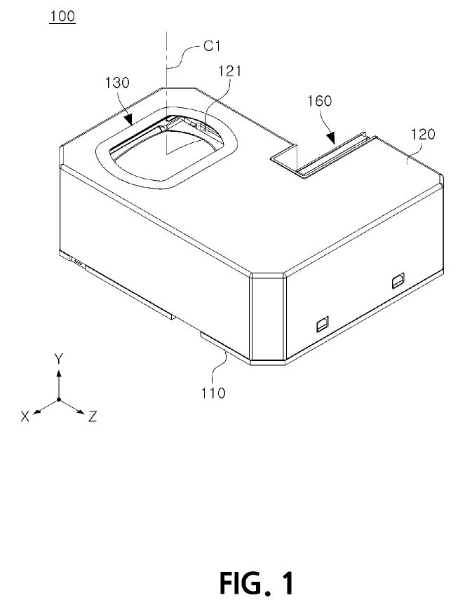

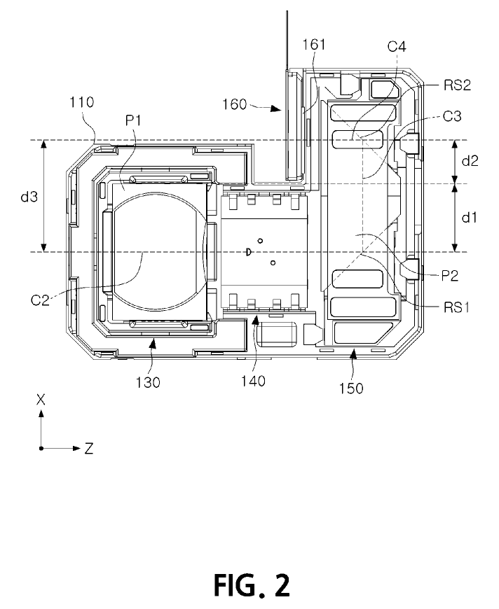

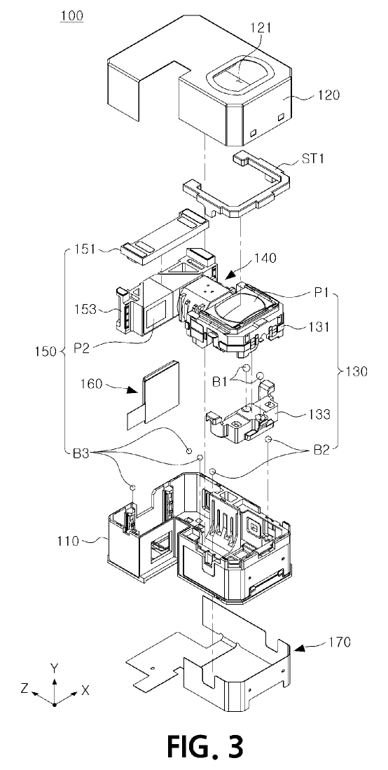

FIG. 1 is a perspective view of a camera module (a first example embodiment) according to the present disclosure; FIG. 2 is a plan view of the camera module according to the present disclosure while a shield can is removed; and FIG. 3 is a schematic exploded perspective view of the camera module according to the present disclosure.

Referring to FIGS. 1 through 3, a camera module 100 according to the present disclosure may change a propagation path of light two times or more.

According to the present disclosure, the camera module 100 may include two or more reflection members P1 and P2 to change the propagation path of light two times or more. The camera module 100 according to the present disclosure has a compact form instead of having a shape elongated in a specific direction, thereby efficiently utilizing a space of the camera module 100 while preventing an unnecessary increase in a size thereof. Simultaneously, the camera module 100 may achieve high-magnification performance by securing a sufficient total track length (TTL).

The camera module 100 may include a housing 110 and a shield can 120 forming an external appearance. The housing 110 may have an internal space in which optical elements are disposed, and the shield can 120 may be coupled to the housing 110 to cover the internal space. The shield can 120 may include an opening 121, and external light may be incident on the camera module 100 through the opening 121.

The camera module 100 may include a plurality of optical modules disposed in the housing 110. A first optical module 130, a second optical module 140, a third optical module 150, and a fourth optical module 160 may be disposed in the housing 110 along the propagation path of light. Each of the first optical module 130, the second optical module 140, the third optical module 150, and the fourth optical module 160 may include at least one optical member.

The first optical module 130 may be exposed outward through the opening 121 of the shield can 120. External light may be incident on the first optical module 130. An incident direction may be a direction parallel to a first optical axis C1. The first optical module 130 may include a first reflection member as an optical member. For example, the first reflection member may be a first prism P1. The first prism P1 may reflect and refract light incident in the direction parallel to the first optical axis C1 into a direction parallel to a second optical axis C2. The second optical axis C2 may be substantially perpendicular to the first optical axis C1.

The second optical module 140 may be spaced apart from the first optical module 130 in a direction parallel to the second optical axis C2. Light emitted from the first optical module 130 in the direction parallel to the second optical axis C2 may be incident on the second optical module 140. The second optical module 140 may include at least one lens L2 as an optical member. At least one lens L2 may be disposed in the direction parallel to the second optical axis C2.

The third optical module 150 may be spaced apart from the second optical module 140 in the direction parallel to the second optical axis C2. Light emitted from the second optical module 140 in the direction parallel to the second optical axis C2 may be incident on the third optical module 150. The third optical module 150 may include a second reflection member as an optical member. For example, the second reflection member may be a second prism P2 including a plurality of reflection surfaces. The second prism P2 may include a first reflection surface RS1 and a second reflection surface RS2 facing each other obliquely. The first reflection surface RS1 and the second reflection surface RS2 may be spaced apart from each other in a direction of a third optical axis C3. Light emitted from the second optical module 140 may be incident on the first reflection surface RS1, and the first reflection surface RS1 may reflect and refract light incident in the direction parallel to the second optical axis C2 into a direction parallel to the third optical axis C3. The third optical axis C3 may be substantially perpendicular to the second optical axis C2. Light reflected and refracted by the first reflection surface RS1 may be incident on the second reflection surface RS2, and may be reflected and refracted again by the second reflection surface RS2 in a direction of a fourth optical axis C4. The fourth optical axis C4 may be substantially parallel to the second optical axis C2.

The fourth optical module 160 may be spaced apart from the third optical module 150 in a direction parallel to the fourth optical axis C4. Light emitted from the third optical module 150 in the direction parallel to the fourth optical axis C4 may be incident on the fourth optical module 160. The fourth optical module 160 may include an image sensor 161. The image sensor 161 may be disposed to have an imaging surface facing the second reflection surface RS2, and light incident on the imaging surface may be converted into an electrical signal and output as an image signal.

According to the present disclosure, the first optical module 130, the second optical module 140, and the third optical module 150 may overlap one another in the internal space of the housing 110 in the direction parallel to the second optical axis C2 (hereinafter, a first direction), and the first optical module 130 may satisfy the following conditional expression.

### d1 > d2.

d1 is a distance in a second direction from the center of an optical member included in the first optical module 130 to the outermost end of the optical member included in the first optical module 130.

d2 is a distance in the second direction from the center of an optical member included in the fourth optical module 160 to the outermost end of the optical member included in the first optical module 130.

In the definitions of d1 and d2, the second direction is a direction perpendicular to the first direction, and may be the direction parallel to the third optical axis C3. In addition, the optical member included in the first optical module 130 is the first prism P1 and the optical member included in the fourth optical module 160 is the image sensor 161, and accordingly, d1 may indicate a distance in the second direction from the center of the first prism P1 (a point at which the first optical axis C1 and the second optical axis C2 intersect) to the outermost end of the first prism P1, and d2 may indicate a distance in the second direction from the center of the image sensor 161 to the outermost end of the first prism P1. Furthermore, d1 may be half of a length of the first prism P1 in a major axis direction.

In addition, according to the present disclosure, the first optical module 130, the second optical module 140, and the third optical module 150 may further satisfy the following conditional expression.

### d3 > 0.

d3 is a distance in the second direction from an optical axis shared by the first optical module 130, the second optical module 140, and the third optical module 150 to the center of an optical member included in the fourth optical module 160.

In the definition of d3, the first optical module 130, the second optical module 140, and the third optical module 150 may share the second optical axis C2, and the optical member included in the fourth optical module 160 is the image sensor 161, and accordingly, d3 may indicate a distance in the second direction from the second optical axis C2 to the center of the image sensor 161.

The example embodiments described in the specification may satisfy all of the above conditional expressions.

Hereinafter, the camera module 100 according to the present disclosure is described in more detail.

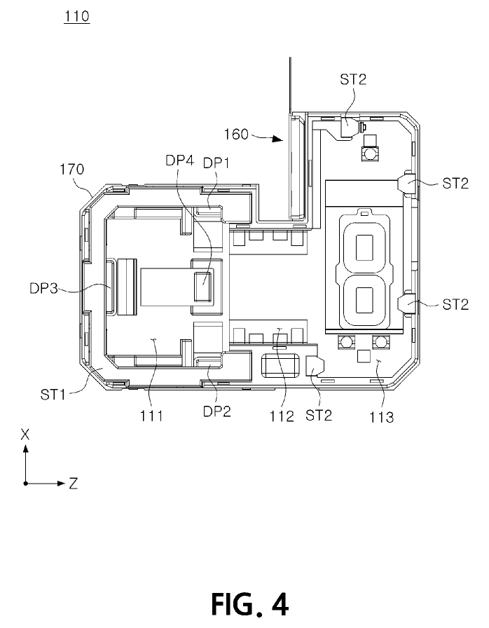

FIG. 4 is a plan view of a housing according to the present disclosure.

Referring to FIG. 4, the internal space of the housing 110 may include a first space 111 in which the first optical module 130 is disposed, a second space 112 in which the second optical module 140 is disposed, and a third space 113 in which the third optical module 150 is disposed.

The first space 111, the second space 112, and the third space 113 may be sequentially arranged in the first direction, and the housing 110 may have a length in the first direction.

Meanwhile, the first space 111, the second space 112, and the third space 113 may have different lengths in the second direction. A length of the housing 110 in the second direction may be determined by sizes of the optical members included in the first optical module 130, the second optical module 140, and the third optical module 150. The length of the housing 110 in the second direction may be reduced once and increased once along the first direction. For example, the housing 110 may have the minimum length in the second direction at the second space 112 in which the second optical module 140 is disposed, and may have the maximum length in the second direction at the third space 113 in which the third optical module 150 is disposed. Accordingly, the length of the housing 110 in the second direction may be reduced in a portion extending from the first space 111 to the second space 112, and may be increased again in a portion extending from the second space 112 to the third space 113.

The fourth optical module (hereinafter, an image sensor module) 160 may be disposed on one side surface of the housing 110 defining the third space 113, and may be disposed to be parallel to the second space 112 in the second direction. For example, the image sensor module 160 may be disposed to overlap the second space 112 in the second direction.

A substrate 170 may be attached to an exterior of the housing 110. For example, the substrate 170 may be bent in a portion thereof and disposed over a plurality of surfaces of the housing 110. A driving coil and a position sensor, which are described below, may be disposed on the substrate 170. The driving coil, the position sensor, and the like may be disposed on the housing 110 by being disposed on the substrate 170, and may be exposed to the internal space through through-holes disposed in the housing 110. However, the above-described shape of the substrate 170 is merely an example, and may have a different shape depending on positions at which the driving coil, the position sensor, and the like are disposed.

A plurality of dampers DP1, DP2, DP3, and DP4 may be disposed on a bottom surface of the housing 110. The plurality of dampers DP1, DP2, DP3, and DP4 may be integrated with a plate disposed on a bottom surface of the housing 110. Each of the plurality of dampers DP1, DP2, DP3, and DP4 may protrude from the bottom surface of the housing 110 toward the first optical module 130, and may serve to alleviate collision and noise between the first optical module 130 and the housing 110, which may occur due to driving of the first optical module 130 and/or an external impact. In addition, each of the plurality of dampers DP1, DP2, DP3, and DP4 may also serve to limit a rotation range of the first optical module 130.

Similarly, a first stopper ST1 may be coupled to the housing 110. The first stopper ST1 may be disposed to face the first optical module 130 in a direction of the first optical axis C1 and a direction of the second optical axis C2. The first stopper ST1 may prevent the first optical module 130 from deviating outward from the first space 111 when an external impact is applied, and may prevent the first optical module 130 from directly colliding with the shield can 120 and the housing 110.

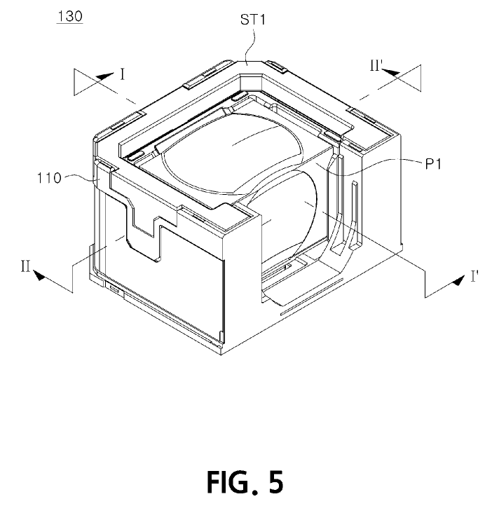

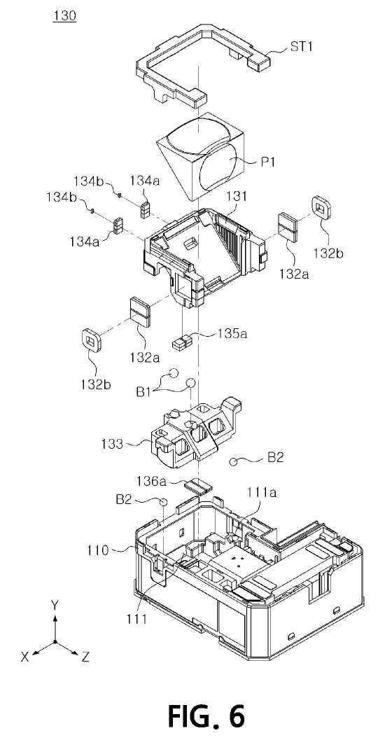

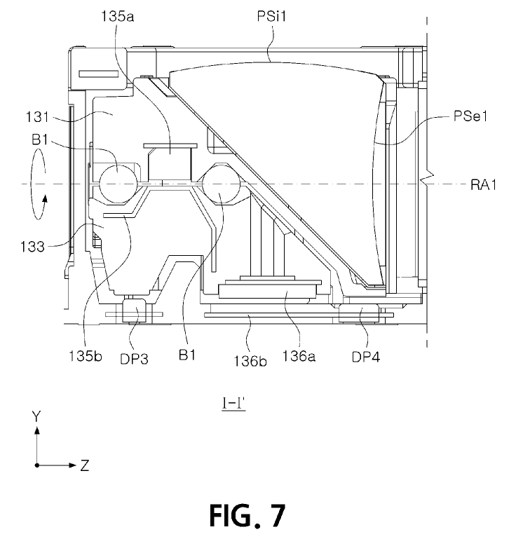

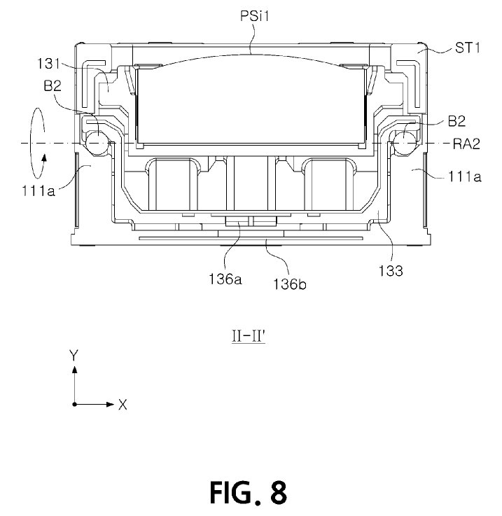

FIG. 5 is a perspective view of the first optical module according to the present disclosure; FIG. 6 is an exploded perspective view of the first optical module according to the present disclosure; FIG. 7 is a cross-sectional view taken along line I-I' of FIG. 5; and FIG. 8 is a cross-sectional view taken along line II-II' of FIG. 5.

The first optical module 130 may include the first prism P1 as an optical member. In an example embodiment, the first prism P1 may be a power prism in which the incident surface PSi1 and exit surface PSe1 of the prism have curvatures in a paraxial region (or at least one of the incident surface and the exit surface may have a curvature in the paraxial region), as illustrated in FIG. 7 and the like. The first prism P1 may change light incident in the direction of the first optical axis C1 into the direction of the second optical axis C2.

The first optical module 130 may be disposed in the first space 111 of the housing 110, and may include a reflection member holder 131 in which the first prism P1 is disposed, and a rotation guide 133 in which the reflection member holder 131 is disposed.

The first optical module 130 may be rotatable about an axis parallel to the second optical axis C2 (hereinafter, a first rotation axis RA1) and an axis parallel to the third optical axis C3 (hereinafter, a second rotation axis RA2). For example, the reflection member holder 131 may be relatively rotated about the first rotation axis RA1 with respect to the rotation guide 133 and the rotation guide 133 may be relatively rotated about the second rotation axis RA2 with respect to the housing 110. The reflection member holder 131 is disposed in the rotation guide 133, and accordingly, the reflection member holder 131 may be rotated together with the rotation guide 133.

A first ball member B1 may be disposed between the reflection member holder 131 and the rotation guide 133. The first ball member B1 may include two ball members spaced apart from each other in a direction of the first rotation axis RA1, and the first rotation axis RA1 may pass through the two ball members. An accommodation groove may be formed in each of the reflection member holder 131 and the rotation guide 133, and the first ball member B1 may be disposed in the accommodation grooves. In this case, the first ball member B1 may maintain a position fixed by the accommodation grooves. The first ball member B1 may form the first rotation axis RA1 by rotating in place by a driving force generated by a driving unit to be described below.

A second ball member B2 may be disposed between the rotation guide 133 and the housing 110. The second ball member B2 may include two ball members spaced apart from each other in the direction of the second rotation axis RA2, and the second rotation axis RA2 may pass through the two ball members. An accommodation groove may be formed in each of the rotation guide 133 and the housing 110, and the second ball member B2 may be disposed in the accommodation grooves. The accommodation groove formed in the housing 110 may be formed in a protrusion 111a protruding from the bottom surface of the housing 110 in the direction of the first optical axis C1. The second ball member B2 may maintain a position fixed by the accommodation grooves. The second ball member B2 may form the second rotation axis RA2 by rotating in place by a driving force generated by the driving unit to be described below.

The first optical module 130 may include a first driving unit that generates a driving force for rotation about the first rotation axis RA1 and the second rotation axis RA2. The first driving unit may include a driving magnet 132a and a driving coil 132b disposed to face each other. The driving magnet 132a can be disposed on two parallel side surfaces of the reflection member holder 131, and the driving coil 132b may be disposed on the substrate 170, while being disposed on two side surfaces of the housing 110 that respectively face the two side surfaces of the reflection member holder 131.

An N pole, a neutral region, and an S pole (or an S pole, a neutral region, and an N pole) in the direction of the first optical axis C1 may be disposed on one surface of the driving magnet 132a facing the driving coil 132b. When power is applied to the driving coil 132b, the driving magnet 132a and the driving coil 132b may generate a driving force in a direction perpendicular to a direction in which the driving magnet 132a and the driving coil 132b face each other. For example, the driving magnet 132a and the driving coil 132b may face each other in the direction of the third optical axis C3, and may generate a driving force in the direction of the first optical axis C1. In this case, depending on directions of currents applied to the two driving coils 132b, the reflection member holder 131 may be rotated about the first rotation axis RA1 or the second rotation axis RA2.

The first damper DP1 and the second damper DP2 may be disposed on the bottom surface of the first space 111 of the housing 110. The first damper DP1 and the second damper DP2 may be spaced apart from each other in the direction of the third optical axis C3 while having the first rotation axis RA1 interposed there between. The reflection member holder 131 may come into contact with the first damper DP1 or the second damper DP2 disposed on the housing 110 while being maximally rotated about the first rotation axis RA1.

In addition, the third damper DP3 and the fourth damper DP4 may be disposed on the bottom surface of the first space 111 of the housing 110. The third damper DP3 and the fourth damper DP4 may be spaced apart from each other in the direction of the second optical axis C2 while having the second rotation axis RA2 interposed therebetween.

The reflection member holder 131 and the rotation guide 133 may come into contact with the third damper DP3 or the fourth damper DP4 disposed on the housing 110 while the reflection member holder 131 and the rotation guide 133 are maximally rotated about the second rotation axis RA2. For example, the rotation guide 133 may come into contact with the third damper DP3, and the reflection member holder 131 may come into contact with the fourth damper DP4.

The reflection member holder 131 may be pulled toward a counterpart member, which is the rotation guide 133. For this purpose, a first magnetic member 135a may be disposed on the reflection member holder 131, and a second magnetic member 135b may be disposed on the rotation guide 133. For example, the first magnetic member 135a disposed on the reflection member holder 131 may be a pulling magnet, and the second magnetic member 135b disposed on the rotation guide 133 may be a pulling yoke. The second magnetic member 135b may be a part of an insert member disposed inside the rotation guide 133.

The first magnetic member 135a and the second magnetic member 135b may be disposed to face each other in the direction of the first optical axis C1. The first magnetic member 135a and the second magnetic member 135b may generate an attractive force in the direction of the first optical axis C1, which is a direction in which the first magnetic member 135a and the second magnetic member 135b face each other. The reflection member holder 131 may be supported by the rotation guide 133 in the direction of the first optical axis C1 by the attractive force generated between the first magnetic member 135a and the second magnetic member 135b. In addition, by the attractive force, the first ball member B1 may stably support rotation of the reflection member holder 131.

The rotation guide 133 may be pulled toward a counterpart member, which is the housing 110. For this purpose, a third magnetic member 136a may be disposed on the rotation guide 133, and a fourth magnetic member 136b may be disposed on the housing 110. For example, the third magnetic member 136a disposed on the rotation guide 133 may be a pulling magnet, and the fourth magnetic member 136b disposed on the housing 110 may be a pulling yoke. The fourth magnetic member 136b may be a part of an insert member disposed inside the housing 110.

The third magnetic member 136a and the fourth magnetic member 136b may be disposed to face each other in the direction of the first optical axis C1. The third magnetic member 136a and the fourth magnetic member 136b may generate an attractive force in the direction of the first optical axis C1, which is a direction in which the third magnetic member 136a and the fourth magnetic member 136b face each other. The rotation guide 133 may be supported by the housing 110 in the direction of the first optical axis C1 by the attractive force generated between the third magnetic member 136a and the fourth magnetic member 136b. In addition, by the attractive force, the second ball member B2 may stably support rotation of the rotation guide 133.

The first optical module 130 may include a sensing unit for sensing a position of the reflection member holder 131. The sensing unit may include a sensing magnet 134a and a position sensor 134b disposed to face each other. The sensing magnet 134a may be disposed on one side surface disposed between the two parallel side surfaces of the reflection member holder 131, and the position sensor 134b may be disposed on the substrate 170, while being disposed on one side surface of the housing 110 that faces the one side surface of the reflection member holder 131. A plurality of sensing magnets 134a and a plurality of position sensors 134b may be provided.

An N pole, a neutral region, and an S pole (or an S pole, a neutral region, and an N pole) may be disposed on one surface of the sensing magnet 134a facing the position sensor 134b in the direction of the first optical axis C1. The position sensor 134b may be disposed to face the neutral region of the sensing magnet 134a. The position sensor 134b may sense the position of the reflection member holder 131 by detecting a magnetic field of the sensing magnet 134a that changes based on rotation of the reflection member holder 131. For example, the position sensor 134b may be provided as a hall sensor.

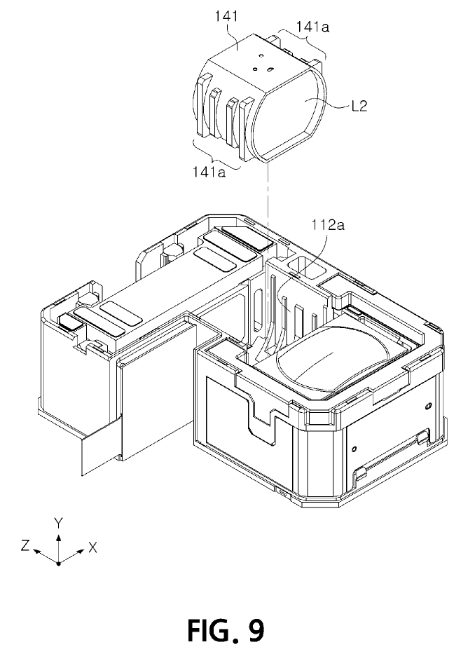

FIG. 9 is an exploded perspective view of the second optical module according to the present disclosure.

The second optical module 140 may include at least one lens (hereinafter, a second lens unit) L2 disposed in the direction of the second optical axis C2 as an optical member. In an example embodiment, the second lens unit L2 may include a D-cut lens. The D-cut lens may include a pair of arc portions facing each other, and a pair of straight portions extending between the pair of arc portions. A distance from the center of the D-cut lens to the pair of arc portions may be a major axis, and a distance from the center of the D-cut lens to the pair of straight portions may be a minor axis.

The second optical module 140 may be disposed in the second space 112 of the housing 110, and may include a lens barrel 141 in which the second lens unit L2 is mounted in the direction of the second optical axis C2. The lens barrel 141 may have a shape corresponding to the second lens unit L2. For example, the lens barrel 141 may have a length in the direction of the second optical axis C2, and a cross section cut in a direction perpendicular to the direction of the second optical axis C2 may have a shape including the pair of arc portions facing each other and the pair of straight portions extending between the pair of arc portions.

The second optical module 140 may be fixedly coupled to the housing 110. For example, the lens barrel 141 may include a plurality of coupling protrusions 141a extending in a major axis direction from an outer side surface corresponding to the pair of arc portions of the lens barrel 141. The plurality of coupling protrusions 141a may be coupled, through an adhesive, to a plurality of coupling grooves 112a formed in the second space 112 of the housing 110.

In another example embodiment of the present disclosure, the second optical module 140 may be relatively movable with respect to the housing 110 instead of the third optical module 150 to be described below. A description thereof is provided below.

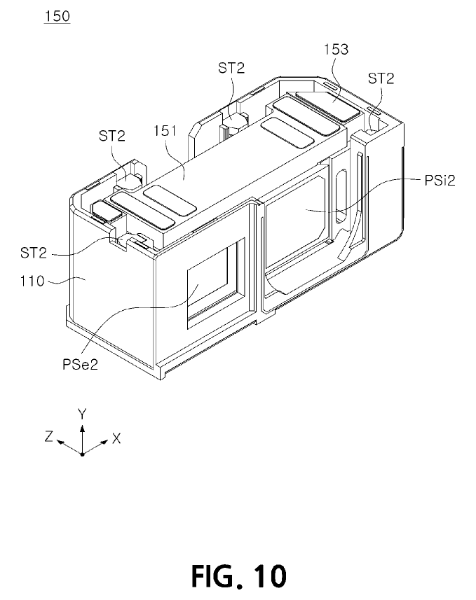

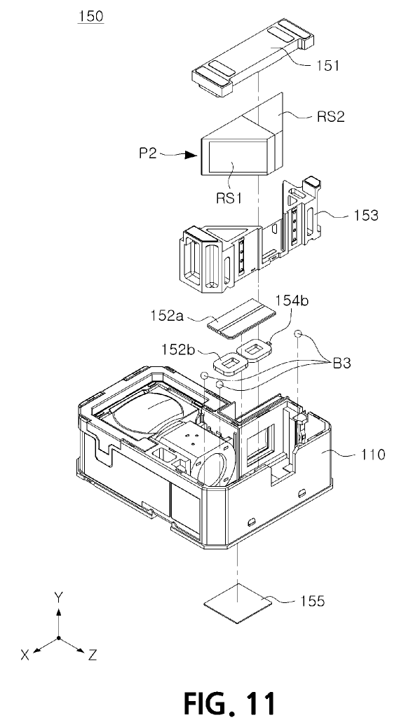

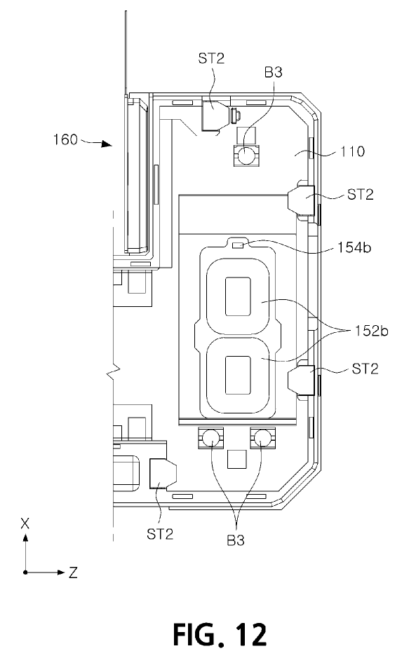

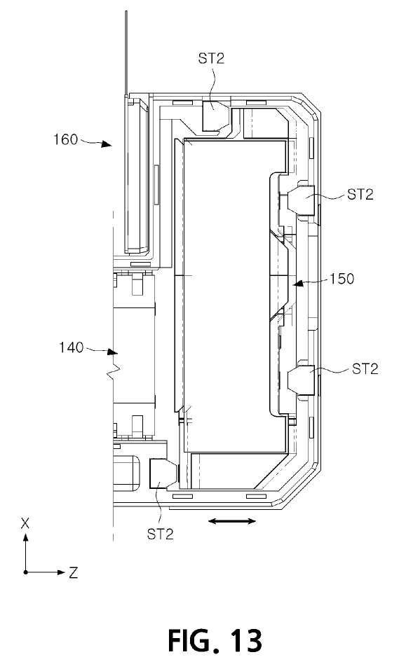

FIG. 10 is a perspective view of the third optical module according to the present disclosure; FIG. 11 is an exploded perspective view of the third optical module according to the present disclosure; FIG. 12 is a plan view of the third space of the housing according to the present disclosure; and FIG. 13 is a view illustrating an autofocus (AF) driving state of the third optical module according to the present disclosure.

The third optical module 150 may include the second prism P2 as an optical member. In an example embodiment, the second prism P2 may include the first reflection surface RS1 and the second reflection surface RS2 facing each other obliquely, as illustrated in FIG. 11 and the like. The first reflection surface RS1 and the second reflection surface RS2 may be spaced apart from each other in the direction of the third optical axis C3, and the second prism P2 may have a length in the direction of the third optical axis C3.

The second prism P2 may change a propagation path of light two times. For example, light incident in the direction of the second optical axis C2 may be changed to the direction of the third optical axis C3 at the first reflection surface RS1, and may be changed again to the direction of the fourth optical axis C4 at the second reflection surface RS2. In this case, the direction of the second optical axis C2, which is a direction in which light is incident on the second prism P2, and the direction of the fourth optical axis C4, which is a direction in which light is emitted from the second prism P2, may be parallel to each other. Accordingly, the incident surface PSi2 and exit surface PSe2 of the second prism P2 may be disposed to be parallel to each other, and may be spaced apart from each other in the direction of the third optical axis C3, which is a length direction of the second prism P2. The incident surface of the second prism P2 may face the second optical module 140 in the direction of the second optical axis C2, and may be disposed obliquely with respect to the first reflection surface RS1. The exit surface of the second prism P2 may face the imaging surface of the image sensor 161 in the direction of the fourth optical axis C4, and may be disposed obliquely with respect to the second reflection surface RS2.

The third optical module 150 may be disposed in the third space 113 of the housing 110, and may include a carrier 153 in which the second prism P2 is disposed, and a cover 151 coupled to an open upper portion of the carrier 153 (based on the drawing).

The carrier 153 may extend in the length direction of the second prism P2, that is, in the direction of the third optical axis C3. In addition, the carrier 153 may have an open shape in each of the direction of the first optical axis C1 and the direction of the second optical axis C2. The carrier 153 may have a shape open toward the shield can 120, and the cover 151 may be coupled to the carrier 153 to cover the second prism P2 while the second prism P2 is seated on the carrier 153. That is, the cover 151 may be disposed between the second prism P2 and the shield can 120. In addition, the carrier 153 may have a shape open toward a side facing the second optical module 140 and the fourth optical module 160. Accordingly, light passing through the second lens unit L2 of the second optical module 140 may be incident on the second prism P2, and light emitted from the second prism P2 may be incident on the image sensor 161.

The third optical module 150 may be moved in the direction parallel to the second optical axis C2. For example, the carrier 153 may be relatively movable with respect to the housing 110 in the direction of the second optical axis C2.

A third ball member B3 may be disposed between the carrier 153 and the housing 110. The third ball member B3 may include three ball members. Among the three ball members, two ball members may be disposed on one side in a length direction of the carrier 153, and one ball member may be disposed on the other side in the length direction of the carrier 153. A guide groove may be formed in each of the carrier 153 and the housing 110, and the third ball member B3 may be disposed in the guide grooves. The guide grooves may have a length in the direction of the second optical axis C2. The third ball member B3 may roll along the guide grooves in the direction of the second optical axis C2 by a driving force generated by the driving unit to be described below.

The third optical module 150 may include a second driving unit that generates a driving force for movement in the direction of the second optical axis C2. The second driving unit may include a driving magnet 152a and a driving coil 152b disposed to face each other. The driving magnet 152a may be disposed on a bottom surface of the carrier 153, and the driving coil 152b may be disposed on the bottom surface of the housing 110 while being disposed on a substrate 170. For example, the driving coil 152b may include two coils disposed in a length direction of the driving magnet 152a.

An N pole, a neutral region, and an S pole (or an S pole, a neutral region, and an N pole) may be disposed on one surface of the driving magnet 152a facing the driving coil 152b in the direction of the second optical axis C2. When power is applied to the driving coil 152b, the driving magnet 152a and the driving coil 152b may generate a driving force in a direction perpendicular to a direction in which the driving magnet 152a and the driving coil 152b face each other. For example, the driving magnet 152a and the driving coil 152b may face each other in the direction of the first optical axis C1, and may generate a driving force in the direction of the second optical axis C2.

When the second prism P2 is moved in the direction of the second optical axis C2, a path of light reflected from the first reflection surface RS1 and a path of light reflected from the second reflection surface RS2 may be changed together, thereby amplifying a movement amount. Accordingly, a focal length may be adjusted using a relatively small movement amount, and a driving space required for focus adjustment may be reduced, and miniaturization of the camera module 100 may thus be possible.

A second stopper ST2 may be coupled to the housing 110. The second stopper ST2 may be disposed to face the carrier 153 in the direction of the second optical axis C2. The second stopper ST2 may be spaced apart in the direction of the second optical axis C2 while having the carrier 153 interposed therebetween. The carrier 153 may come into contact with the second stopper ST2 while the carrier 153 is maximally moved in the direction of the second optical axis C2. The second stopper ST2 may limit a moving range of the carrier 153 and may prevent collision between the carrier 153 and the housing 110.

The carrier 153 may be pulled toward a counterpart member, which is the housing 110. For this purpose, a yoke 155 may be disposed on the bottom surface of the housing 110 to face the driving magnet 152a of the carrier 153. For example, the yoke 155 may be disposed on an outer surface of the substrate 170 on which the driving coil 152b is disposed.

The driving magnet 152a and the yoke 155 may be disposed to face each other in the direction of the first optical axis C1. The driving magnet 152a and the yoke 155 may generate an attractive force in the direction of the first optical axis C1, which is a direction in which the driving magnet 152a and the yoke 155 face each other. The carrier 153 may be supported by the housing 110 in the direction of the first optical axis C1 by the attractive force generated between the driving magnet 152a and the yoke 155. In addition, by the attractive force, the third ball member B3 may stably support movement of the carrier 153.

The third optical module 150 may further include a position sensor 154b for sensing a position of the carrier 153. The position sensor 154b may be disposed on the substrate 170 together with the driving coil 152b and may be disposed on the housing 110. The position sensor 154b may be disposed to face the neutral region of the driving magnet 152a. For example, the position sensor 154b may be provided as a hall sensor.

Hereinafter, camera modules 200 and 300 according to other example embodiments of the present disclosure are described. Redundant descriptions of the above-described camera module 100 are omitted.

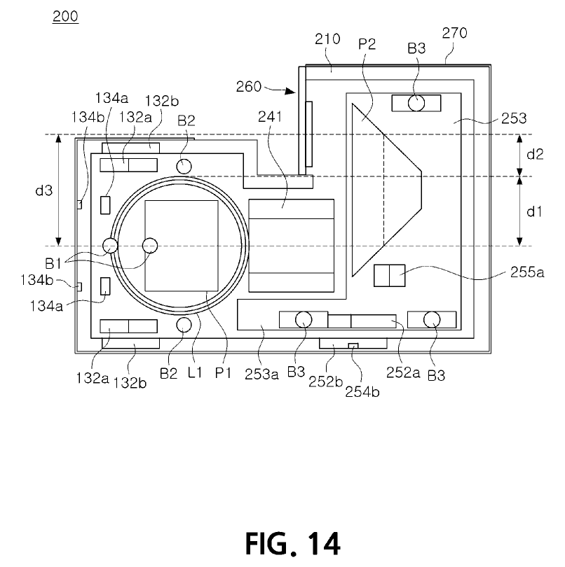

FIG. 14 is a schematic plan view of a camera module (a second example embodiment) according to the present disclosure.

Referring to FIG. 14, a first optical module may include, as optical members, the first prism P1 and at least one lens (hereinafter, a first lens unit) L1 disposed on an object side of the first prism P1. At least one lens included in the first lens unit L1 may be disposed in the direction of the first optical axis C1, and the first lens unit L1 and the first prism P1 may also be disposed along the first optical axis C1. Light incident on the camera module 200 may be incident on the first prism P1 after being refracted by the first lens unit L1. The first prism P1 does not need to have a separate refractive power, and the incident surface and exit surface of the first prism P1 may be flat surfaces.

When the first optical module is viewed in the direction of the first optical axis C1, a diameter of the first lens unit L1, or a length of the first lens unit L1 in a major axis direction when the first lens unit L1 includes a D-cut lens, may be greater than a length of the first prism P1 in the major axis direction. Accordingly, the maximum outer diameter of the first lens unit L1 may be greater than the length of the first prism P1 in the major axis direction, and accordingly, d1 and d2 in the above-described conditional expression may be defined based on the first lens unit L1.

Meanwhile, light rays may converge by the first lens unit L1 disposed on the object side of the first prism P1, and accordingly, sizes of the second lens unit L2 disposed after the first prism P1 and a lens barrel 241 in which the second lens unit L2 is mounted may be additionally reduced.

The first lens unit L1 may be rotated together with the first prism P1 about the first rotation axis RA1 and the second rotation axis RA2, or may be a fixed member fixedly disposed on a housing 210.

A carrier 253 in which the second prism P2 is disposed may have an asymmetric shape with respect to the second optical axis C2. The carrier 253 may include an extension portion 253a extending in the direction of the second optical axis C2. The extension portion 253a may be disposed in a space secured between the lens barrel 241 and the housing 210. That is, the extension portion 253a may be disposed in a space of the housing 210 in which the second optical module is disposed and may overlap the lens barrel 241 in the direction of the third optical axis C3, and may further reduce the length of the housing 210 in the first direction.

One of the third ball members B3 supporting movement of the carrier 253 in the direction of the second optical axis C2 may be disposed in the extension portion 253a. Accordingly, an area of a support region formed by the third ball member B3 may be increased, thereby more stably supporting movement of the carrier 253.

A driving magnet 252a and a driving coil 252b may be disposed on one side surface of the carrier 253 including the extension portion 253a and one side surface of the housing 210 facing the one side surface of the carrier 253. The driving coil 252b may be disposed on a substrate 270 and disposed on the housing 210, and a position sensor 254b may be disposed on the substrate 270 together with the driving coil 252b. A pulling magnet 255a may be separately disposed on a bottom surface of the carrier 253. The pulling magnet 255a may be disposed inside a support region connecting the carrier 253 and the third ball member B3.

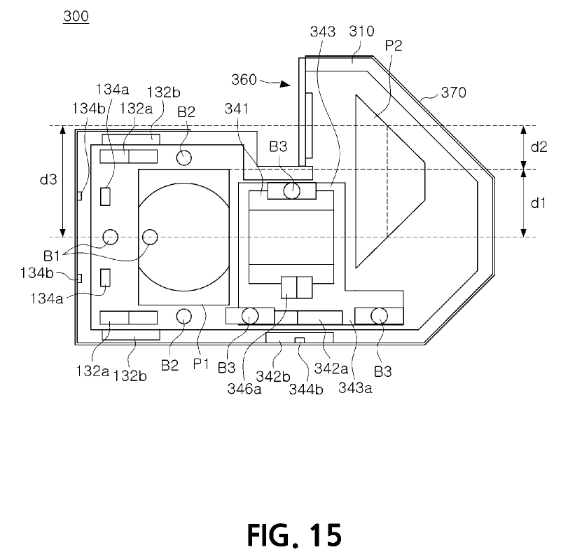

FIG. 15 is a schematic plan view of a camera module (a third example embodiment) according to the present disclosure.

Referring to FIG. 15, during focus adjustment, a second optical module may be moved in the direction of the second optical axis C2 instead of a third optical module. That is, the second lens unit L2 may be a moving member relatively movable with respect to a housing 310, and the second prism P2 may be a fixed member fixedly disposed on the housing 310.

Meanwhile, as the second prism P2 is fixedly disposed on the housing 310 and a moving space of the second prism P2 thus becomes unnecessary, both side corners of the housing 310 formed by meeting of side surfaces defining the third space may be changed to have a shape corresponding to the second prism P2. For example, corner portions of side surfaces of the housing 310 defining the third space may have a cut shape, and the housing 310 may include surfaces parallel to the first and second reflection surfaces RS1 and RS2 of the second prism P2. Accordingly, a volume of the housing 310 may be further reduced.

The second optical module may include a carrier 343 in which a lens barrel 341 is disposed and which is relatively movable with respect to the housing 310 in the direction of the second optical axis C2. The third ball member B3 may be disposed between the carrier 343 and the housing 310. The third ball member B3 may include three ball members, among which two ball members may support one side of the carrier 343 based on the second optical axis C2, and remaining one ball member may support the other side of the carrier 343.

The carrier 343 may have an asymmetric shape with respect to the second optical axis C2. One side of the carrier 343 may include an extension portion 343a extending in the direction of the second optical axis C2. Accordingly, one side of the carrier 343 in which the two ball members are disposed may have a greater length in the direction of the second optical axis C2 than the other side of the carrier 343 in which one ball member is disposed. One of two ball members disposed on one side of the carrier 343 may be disposed in the extension portion 343a, and the carrier 343 may be stably driven.

A driving magnet 342a and a driving coil 342b may be disposed on one side surface of the carrier 343 including the extension portion 343a and one side surface of the housing 310 facing the one side surface of the carrier 343. The driving coil 342b may be disposed on a substrate 370 and disposed on the housing 310, and a position sensor 344b may be disposed on the substrate 370 together with the driving coil 342b. A pulling magnet 346a may be separately disposed on a bottom surface of the carrier 343. The pulling magnet 346a may be disposed inside a support region connecting the carrier 343 and the third ball member B3.

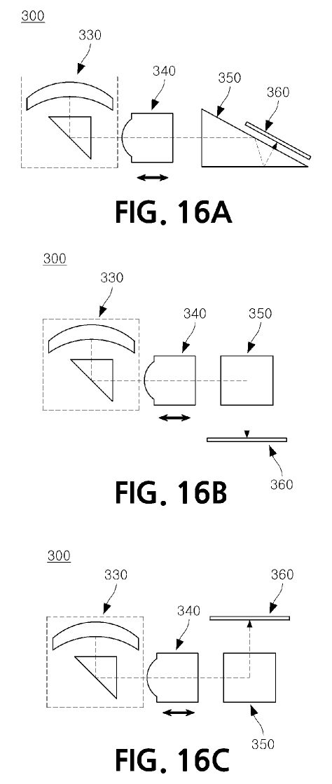

FIGS. 16A through 16C are views illustrating modified example embodiments of the third optical module included in the camera module illustrated in FIG. 15.

As illustrated in FIG. 15, in a camera module structure in which the second optical module performs autofocus (AF) driving and the third optical module is a fixed member, the third optical module may be modified as illustrated in FIGS. 16A through 16C.

Referring to FIGS. 16A through 16C, the first and second reflection surfaces RS1 and RS2 of the second prism P2 may have orientations different from those illustrated in FIG. 15 and the like, and a position of an image sensor module 360 may be changed. However, even in this case, a first optical module 330, a second optical module 340, a third optical module 350, and a fourth optical module 360 may be disposed to satisfy the conditional expressions described above.

Referring to FIG. 16A, the second prism P2 may be provided as a slanted prism. In the slanted prism, the first reflection surface RS1 may be disposed at an angle other than 45 degrees with respect to the second optical axis C2, and the second reflection surface RS2 may be disposed at an angle different from 45 degrees with respect to the third optical axis C3. A path of light changed at the first reflection surface RS1 (the direction of the third optical axis C3) and a path of light changed at the second reflection surface RS2 (the direction of the fourth optical axis C4) may not be perpendicular to the direction of the second optical axis C2. Light reflected from the second reflection surface RS2 may be emitted through the first reflection surface RS1. That is, the first reflection surface RS1 may also function as an exit surface, and the image sensor module 360 may be disposed to be parallel to the first reflection surface RS1. Referring to FIGS. 16B and 16C, the path of light changed at the first reflection surface RS1 (the direction of the third optical axis C3) and the path of light changed at the second reflection surface RS2 (the direction of the fourth optical axis C4) may be perpendicular to each other, and the path of light changed at the second reflection surface RS2 (the direction of the fourth optical axis C4) may be parallel to the direction of the first optical axis C1. Accordingly, the image sensor module 360 may be disposed on the bottom surface or top surface of the housing 310.

As set forth above, the example embodiments of the present disclosure may simultaneously achieve the miniaturization and high performance of the camera module.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a housing comprising an internal space;
a first optical module, a second optical module, and a third optical module sequentially arranged in the internal space of the housing along a propagation path of light; and
a fourth optical module disposed in the housing and configured to receive light passing through the third optical module,
wherein the first optical module, the second optical module, and the third optical module are arranged to overlap one another in a first direction, and
wherein the first optical module, the second optical module, the third optical module, and the fourth optical module are arranged in the housing to satisfy the following conditional expression:
d1 > d2,
where d1 is a distance in a second direction from a center of an optical member included in the first optical module to an outermost end of the optical member included in the first optical module, and d2 is a distance in the second direction from a center of an optical member included in the fourth optical module to the outermost end of the optical member included in the first optical module, the second direction being a direction perpendicular to the first direction.

2. The camera module according to claim 1, wherein the first optical module comprises a first reflection member configured to change a traveling direction of light incident in a direction parallel to a first optical axis into a direction parallel to a second optical axis,
wherein the second optical module comprises one or more lenses disposed in the direction parallel to the second optical axis,
wherein the third optical module comprises a second reflection member configured to change a traveling direction of light incident in the direction parallel to the second optical axis a plurality of times, and
wherein the first direction is the direction parallel to the second optical axis.

3. The camera module according to claim 2, wherein the first optical module, the second optical module, the third optical module, and the fourth optical module further satisfy the following conditional expression:
d3 > 0,
where d3 is a distance in the second direction from the second optical axis to the center of an optical member included in the fourth optical module.

4. The camera module according to claim 2, wherein the first reflection member has a minor axis parallel to the first direction and a major axis parallel to the second direction, and
wherein the outermost end of the optical member included in the first optical module is one end of the first reflection member in a major axis direction.

5. The camera module according to claim 4, wherein the first reflection member comprises an incident surface on which light is incident, an exit surface from which light is emitted, and a reflection surface on which light incident on the incident surface is reflected toward the exit surface, and
wherein one or more of the incident surface and the exit surface has a curvature in a paraxial region.

6. The camera module according to claim 2, wherein the first optical module comprises one or more lenses disposed on an object side of the first reflection member and disposed in a direction parallel to the first optical axis, and
wherein the outermost end of the optical member included in the first optical module is one end of a lens having a maximum outer diameter among the one or more lenses.

7. The camera module according to claim 2, wherein the second reflection member comprises:
a first reflection surface on which light incident in the direction parallel to the second optical axis is reflected into a direction parallel to a third optical axis; and
a second reflection surface on which light incident in the direction parallel to the third optical axis is reflected into a direction parallel to a fourth optical axis.

8. The camera module according to claim 2, wherein the second reflection member comprises a reflection surface having an angle other than 45 degrees with respect to the second optical axis.

9. The camera module according to claim 2, wherein the first optical module is configured to be rotatable with respect to the housing about a first rotation axis and a second rotation axis perpendicular to each other, and
wherein the second optical module or the third optical module is configured to be movable with respect to the housing in a direction parallel to the second optical axis.

10. The camera module according to claim 9, wherein the first rotation axis is parallel to the second optical axis.

11. The camera module according to claim 10, wherein the first optical module comprises a reflection member holder in which the first reflection member is disposed, and a rotation guide in which the reflection member holder is disposed,
wherein a first ball member is disposed between the reflection member holder and the rotation guide and spaced apart in a direction of the first rotation axis, and
wherein a second ball member is disposed between the rotation guide and the housing and spaced apart in a direction of the second rotation axis.

12. The camera module according to claim 9, wherein the second optical module or the third optical module comprises:
a carrier in which an optical member is mounted; and
a plurality of ball members disposed between the carrier and the housing and configured to guide movement of the carrier in the direction parallel to the second optical axis.

13. The camera module according to claim 12, wherein one side of the carrier extends further than the other side of the carrier in the direction parallel to the second optical axis,
wherein the plurality of ball members are divided and disposed on the one side and the other side of the carrier, and
wherein the number of ball members disposed on the one side of the carrier is greater than the number of ball members disposed on the other side of the carrier.

14. The camera module according to claim 12, wherein the second optical module is configured to move in the direction parallel to the second optical axis, and
wherein the housing comprises surfaces parallel to reflection surfaces of the second reflection member.

15. A camera module comprising:
a housing having a length in a first direction and a second direction perpendicular to the first direction;
a first optical module disposed in a first space of the housing;
a second optical module disposed in a second space of the housing; and
a third optical module disposed in a third space of the housing,
wherein the first space, the second space, and the third space are sequentially arranged in the first direction and have different lengths in the second direction.

16. The camera module according to claim 15, wherein, among the first space, the second space, and the third space, the second space has a minimum length in the second direction, and the third space has a maximum length in the second direction.

17. The camera module according to claim 15, further comprising:
an image sensor module including an image sensor disposed in the housing and facing the third optical module,
wherein the first optical module, the second optical module, the third optical module, and the image sensor module are disposed in the housing to satisfy the following conditional expression:
d1 > d2,
where d1 is a distance in the second direction from a center of an optical member included in the first optical module to an outermost end of the optical member included in the first optical module, and d2 is a distance in the second direction from a center of the image sensor to the outermost end of the optical member included in the first optical module.

18. The camera module according to claim 17, wherein the first optical module comprises a first reflection member configured to change a traveling direction of light incident in a direction parallel to a first optical axis into a direction parallel to a second optical axis, and
wherein light emitted from the first optical module sequentially passes through the second optical module and the third optical module.

19. The camera module according to claim 18, wherein the first optical module, the second optical module, the third optical module, and the image sensor module further satisfy the following conditional expression:
d3 > 0,
where d3 is a distance in the second direction from the second optical axis to the center of the image sensor.

20. The camera module according to claim 18, wherein the first optical module further comprises a first lens unit disposed on an object side of the first reflection member, and
wherein a maximum outer diameter of the first lens unit is greater than a length of the first reflection member in a length direction.

21. The camera module according to claim 18, wherein the third optical module comprises a second reflection member,
wherein the second reflection member comprises:
a first reflection surface on which a traveling direction of light incident in the direction parallel to the second optical axis is changed into a direction parallel to a third optical axis, and
a second reflection surface which is spaced apart from the first reflection surface in a direction of the third optical axis and on which a traveling direction of light incident in the direction parallel to the third optical axis is changed into a direction parallel to a fourth optical axis.

22. A camera module comprising:
a first lens unit comprising one or more lenses disposed in a first optical axis direction;
a first reflection member spaced apart from the first lens unit in the first optical axis direction;
a second lens unit spaced apart from the first reflection member in a second optical axis direction and comprising one or more lenses disposed in the second optical axis direction;
a second reflection member spaced apart from the second lens unit in the second optical axis direction and comprising a plurality of reflection surfaces; and
an image sensor facing the second reflection member.

23. The camera module according to claim 22, wherein the first reflection member is configured to be rotatable about a first rotation axis and a second rotation axis perpendicular to each other, and
wherein one of the first rotation axis and the second rotation axis is parallel to the second optical axis direction.

24. The camera module according to claim 23, wherein the first lens unit is rotated together with the first reflection member about the first rotation axis and the second rotation axis.

25. The camera module according to claim 22, wherein the second reflection member comprises a first reflection surface and a second reflection surface spaced apart from each other in a third optical axis direction perpendicular to the second optical axis direction.

26. The camera module according to claim 22, wherein one of the second lens unit and the second reflection member is configured to be movable in the second optical axis direction.
